(19) United States
(12) Patent Application Publication
(10) Pub. No.: US 2019/0300093 A1
(43) Pub. Date: Oct. 3, 2019

(54) KICK SCOOTER

(71) Applicant: FORMQUADRAT GMBH, Linz (AT)

(72) Inventor: Stefan Degn, Altmünster (AT)

(21) Appl. No.: 16/339,142

(22) PCT Filed: Sep. 29, 2017
(86) PCT No.: PCT/AT2017/060245

§ 371 Date: Apr. 3, 2019

(30) Foreign Application Priority Data
Oct. 3, 2016 (AT) A 50891/2016

(51) Int. Cl. B62K 3/00; B62L 1/02

(52) U.S. Cl. CPC B62K 3/002; B62L 3/02; B62L 1/02

(57) ABSTRACT

The invention relates to a kick scooter with a deck, a handlebar arranged at an angle to the deck, and front and rear roiling devices. A particularly advantageous driving behavior can be achieved when the rear rolling device has a plurality of rollers arranged along a curved carrier element, each axle of the rollers substantially forming a tangent to a center line of the carrier element.

The invention relates to a kick scooter with a deck, a handlebar arranged at an angle to the deck, and front and rear rolling devices, wherein the rear rolling device has a plurality of rollers arranged along a curved carrier element, and wherein the axles of the rollers each substantially forms a tangent to a center line of the carrier element.

Conventional kick scooters generally have two wheels, one as a front rolling device and one as a rear rolling device, which are arranged on a deck. This design is essentially intended for athletic transportation. The driving dynamics are generally inadequate for athletic use. Because of the single wheels, the inclination of the deck in relation to the underlying surface can only be changed to a very limited extent during cornering. In combination with the comparatively small diameter of the wheels, which is required by the design, an inclination toward the interior of the curve, for example, as with motorcycles, is thus not possible.

An arrangement of multiple wheels on a curved carrier element is already known from a skateboard. The outer wheels are thus inclined in relation to the longitudinal axis of the skateboard to ensure the steering capability. However, it is to be noted in this case that with moderate inclination, the possible curve radii are substantially less than with conventional skateboards. If the inclination is increased, the driving dynamics become very unstable and difficult to learn. Such solutions are known, for example, from WO 1995/03200 A, U.S. Pat. No. 5,553,874 A, and also EP 1 287 860 A.

The object of the present invention is to improve the driving dynamics of a kick roller, and simultaneously to achieve good steering capability with small curve radii.

This object is achieved according to the invention in that the front rolling device is embodied as a single steerable wheel. The riding behavior during athletic use can thus be significantly improved. The essential advantage of the solution according to the invention is that the “conventional” front wheel describes a precisely defined trajectory dependent on the steering angle, while the rear rolling device can pass through different trajectories as a function of the inclination about the longitudinal axis. The riding behavior can thus be positively influenced.

The use of a curved carrier element in the form of a circular segment is particularly advantageous in this case. However, the wheels could also be held individually along an envelope curve. The envelope curve of a substantially larger, wider wheel is generated from the outer surfaces of the rollers by this arrangement. At the same time, the space requirement is very small. The arrangement can thus be arranged on the side of the deck facing toward the underlying surface.

An arrangement has proven to be particularly advantageous in which the rollers are arranged essentially adjacent to one another. In addition, it is particularly advantageous in practice if the axles of the rollers of the rear rolling device all lie in one plane, and each axle has an angle in relation to an adjacent axle which is preferably between 3° and 20°, particularly preferably between 8° and 15°. The riding behavior thus remains independent of the angle of the deck and the underlying surface and prevents unexpected movements while cornering.

In an alternative embodiment, the rollers of the rear rolling device can be arranged offset in the longitudinal direction of the kick scooter. Some rollers are thus located in front of other rollers in the riding direction.

The use of an odd number of rollers has proven to be particularly well suitable, since only one wheel is thus ridden during straight-ahead travel. The friction losses are thus low, on the one hand, and small underlying surface irregularities do not cause a change of the active wheel, on the other hand. Alternative embodiments could use three to eleven, preferably five to nine rollers. The use of seven rollers is particularly well suitable.

For comfortable driving dynamics, the angle between the plane and the deck is approximately 90°. If the plane is inclined to the rear, a feeling of sliding to the side is generated, similar to carving using a snowboard. It has proven to be able to be individualized particularly well if this angle is settable. A particularly multifaceted setting option results if the rollers are offset in the longitudinal direction, since in this manner the shape of the envelope curve can be changed nearly arbitrarily. It is thus possible, for example, to move multiple middle rollers into a horizontal plane in one position, so that the kick scooter can roll simultaneously thereon and is thus particularly attitude-stable. The scooter can therefore stand without additional aids.

The front rolling device is particularly advantageously embodied as a single wheel, which is preferably connected to the handlebar. The front wheel can have the same diameter as the rear wheels in embodiments optimized for skate parks, since typically smooth, hard, and obstacle-free roadways are available in skate parks. For use on the street, the front wheel should have a larger diameter than the rear wheel, to be insensitive to irregularities and small obstacles like rocks. The front wheel can be embodied as a solid plastic wheel, but can also, above all at larger diameters, be a pneumatic tire. Alternatively, two wheels could also be used here, for example, with an Ackermann steering system.

The use of a brake is particularly advantageous for use as an urban means of transportation. This brake can be embodied as a lever having an actuating surface and a friction block. In this case, an essentially uniformly distributed force is exerted on all rollers of the rear rolling device in the braking procedure. An alternative embodiment of a brake could drive friction wedges between the wheels. In a further alternative of the brake having a lever and actuating surface, the friction block could engage directly on the underlying surface. Furthermore, a fixed friction block arranged behind the rear axle on the underside of the deck could function as a brake. The scooter is braked by slightly raising the front wheel, i.e., a so-called “wheelie”, which can be achieved by weight displacement onto the rear foot.

The advantage results due to a wide deck of standing more comfortably in comparison to conventional scooters and the option of being able to assume different foot positions - one behind another and also next to one another. The deck can be embodied as contoured and curved. A resilient, flexing riding feeling can thus be achieved, wherein shocks due to ground irregularities can be absorbed. This can be adapted to optimum values by the selection of material, layer thickness, and optional glass fiber or frame reinforcement. A maximum cornering inclination with a comfortable standing option is enabled by the contouring of the deck.

Particularly good transportability is achieved by a joint of a connecting element between deck and handlebar. The handlebar can thus be collapsed toward the deck.

An exemplary embodiment of the invention will be explained in greater detail hereafter on the basis of the figures. In the figures:

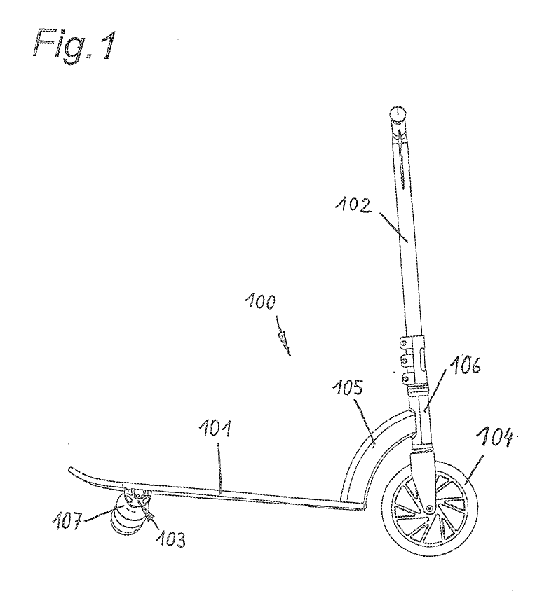

FIG. 1 shows a kick scooter according to the invention in a side view;

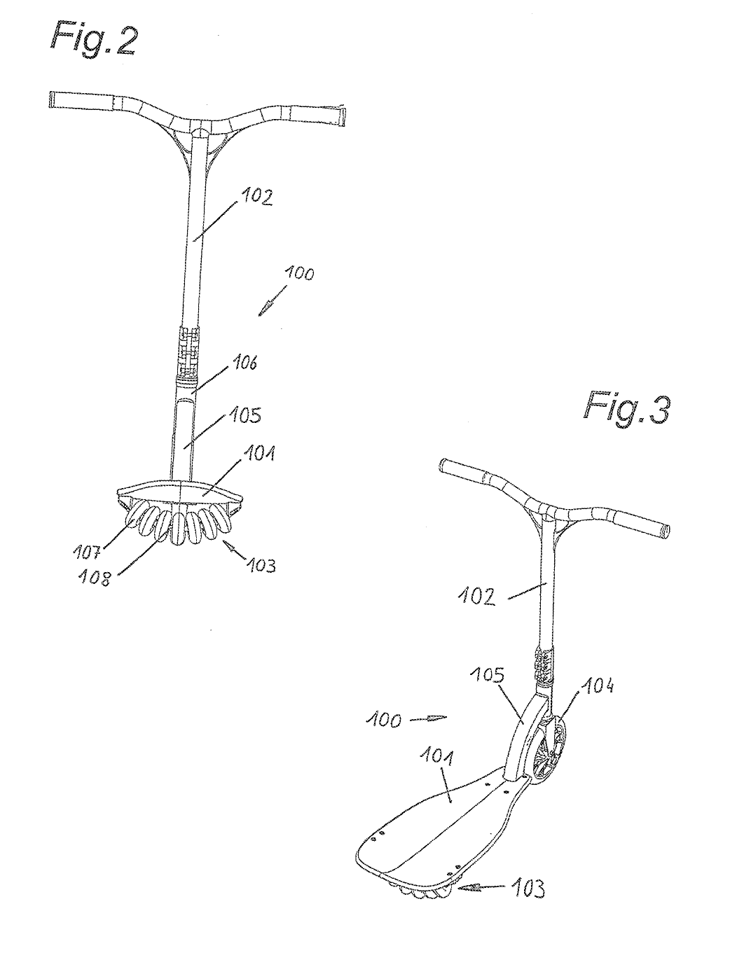

FIG. 2 shows the kick scooter according to the invention from FIG. 1 in a view from the rear;

FIG. 3 shows the kick scooter according to the invention from FIG. 1 in a diagonal view;

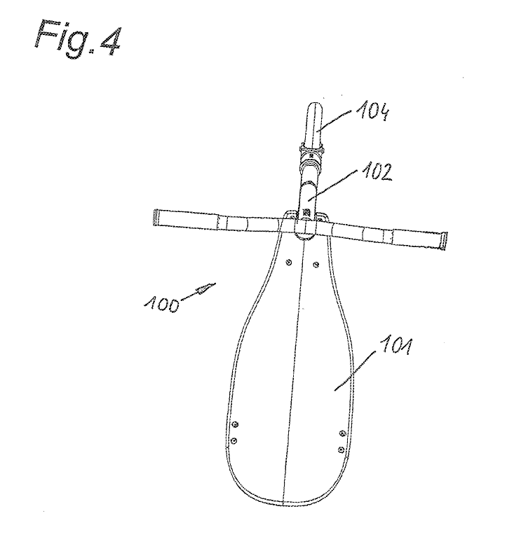

FIG. 4 shows the kick scooter according to the invention from FIG. 1 in a view from above;

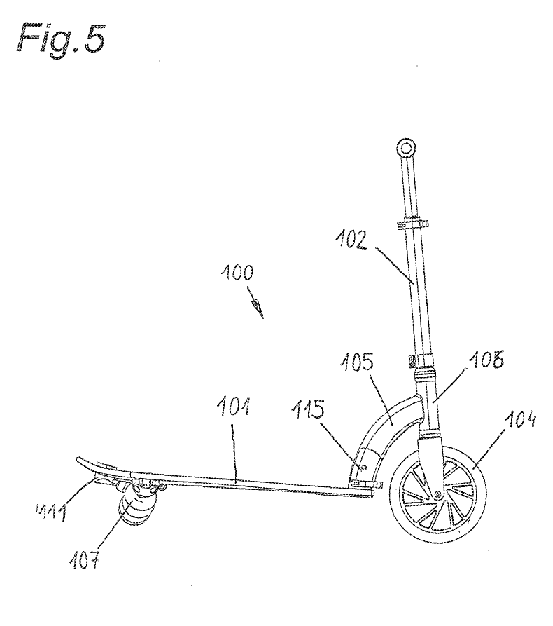

FIG. 5 shows another kick scooter according to the invention in a side view;

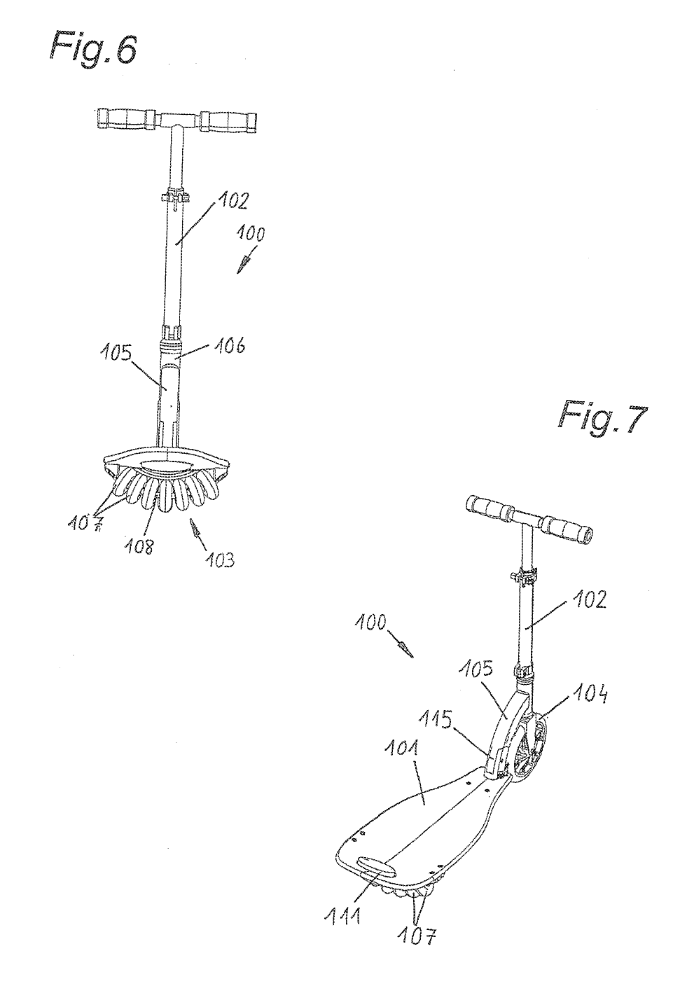

FIG. 6 shows the kick scooter according to the invention from FIG. 5 in a view from the rear;

FIG. 7 shows the kick scooter according to the invention from FIG. 5 in a diagonal view;

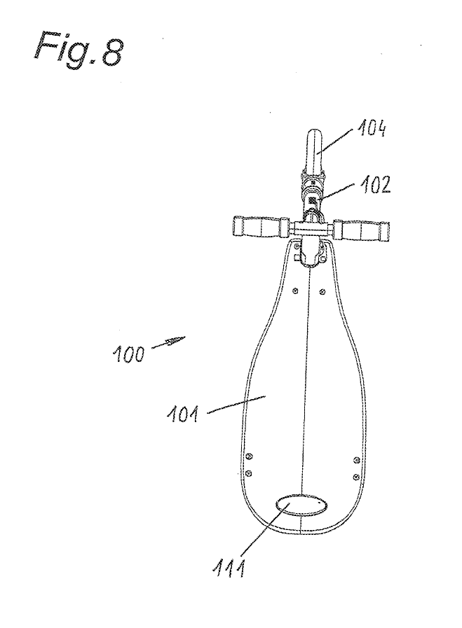

FIG. 8 shows the kick scooter according to the invention from FIG. 5 in a view from above;

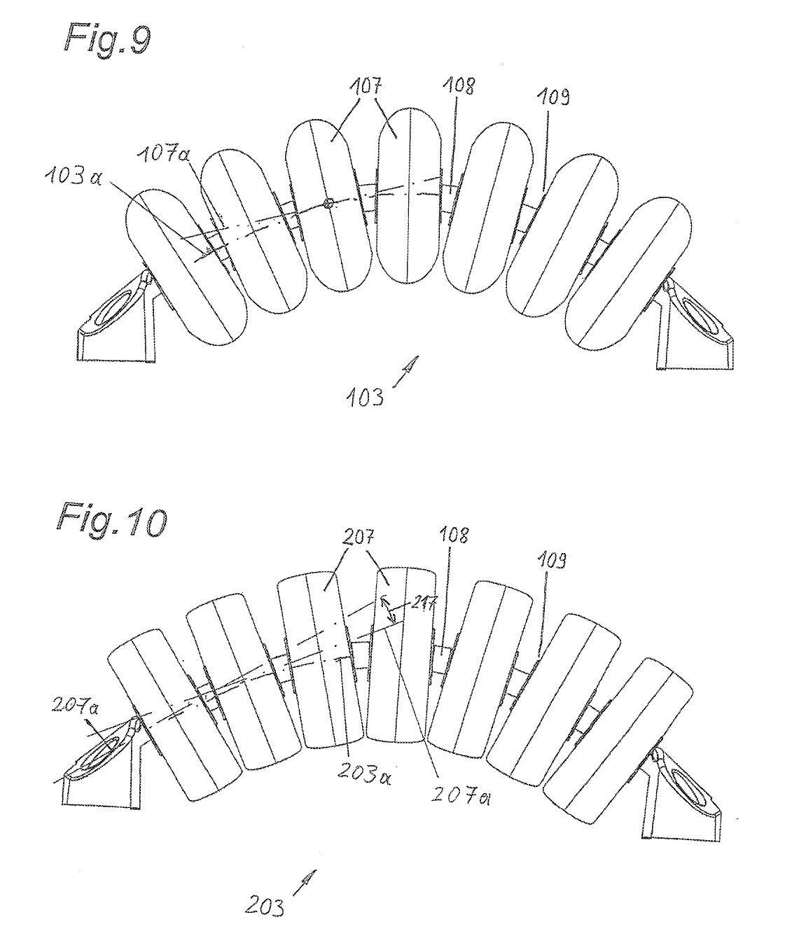

FIG. 9 shows the rear rolling device of a kick scooter according to the invention from FIG. 1 or FIG. 5;

FIG. 10 shows an alternative embodiment having barrel-shaped rollers of a rear rolling device of a kick scooter according to the invention;

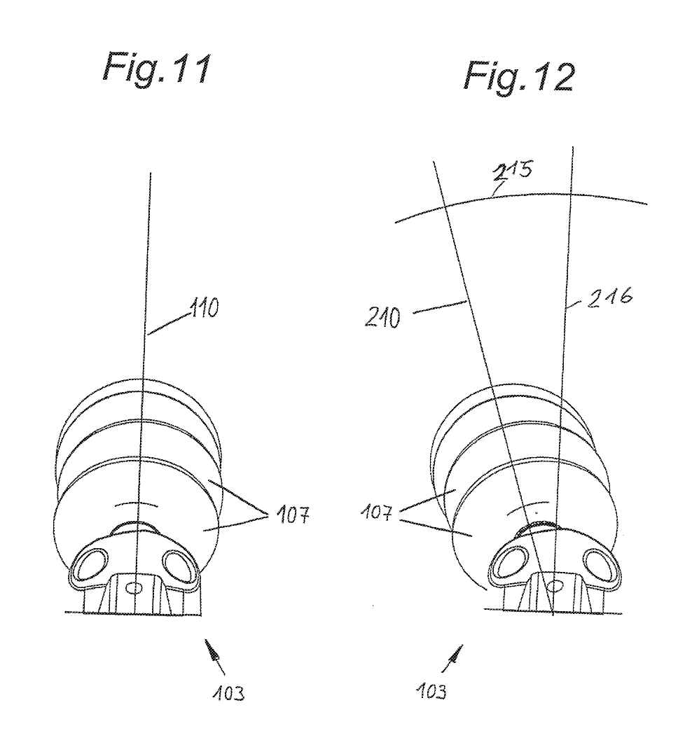

FIG. 11 shows a rear rolling device of a kick scooter according to the invention from FIG. 1 or FIG. 5 in a side view having the plane which is formed by the axles of the rollers perpendicular to the deck;

FIG. 12 shows the rear rolling device from FIG. 11, at a different angle to the deck;

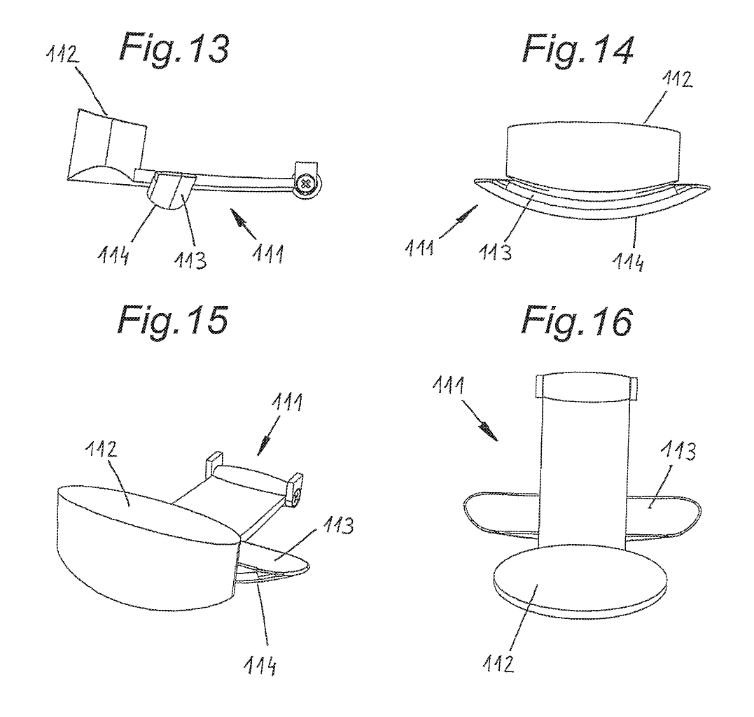

FIG. 13 shows the brake lever of a kick scooter according to the invention from FIG. 1 or FIG. 5 in a side view;

FIG. 14 shows the brake lever from FIG. 13 in a view from the rear;

FIG. 15 shows the brake lever from FIG. 13 in a diagonal view; and

FIG. 16 shows the brake lever from FIG. 13 in a view from above.

A kick scooter 100 according to the invention having a deck 101 and a handlebar 102 is shown in FIGS. 1 to 4. Furthermore, the kick scooter 100 has a rear rolling device 103 and a front rolling device 104. A bracket 105 having a bearing bush 106 is fixedly connected to the deck 101. The handlebar 102 is guided through the bearing bush. To achieve a steering capability, the front rolling device 104 is embodied as a single wheel, which is arranged on the handlebar 102. The rear rolling device is arranged on the side of the deck facing toward the ground in the usage position.

The rear rolling device 103 has seven rollers 107, which are arranged essentially adjacent to one another on a carrier element 108. The carrier element 108 is embodied as circularly curved. Each roller 107 has a recess in its axle for accommodating a roller bearing for guiding through the carrier element. Each roller is essentially normal to the tangent which leads through the center line of the carrier element at the point of the center of the roller 107.

Another embodiment variant 200 is shown in FIGS. 5 to 8, wherein equivalent parts have identical reference signs. This embodiment variant is also designed for athletic transportation. For this purpose, a joint 215 is arranged in the bracket 105. This enables the handlebar 102 to be collapsed parallel to the deck, in order to enable simpler transportation and storage. To enable an even more compact form, the handlebar 102 is shaped narrower and is embodied so it can be divided. In addition, a brake lever 111 is pivotably connected to the deck 101 in the region of the rear rolling device 103 for safer riding.

The rear rolling device 103 is shown in detail in FIG. 9. The wheels are embodied rounded to ensure optimum driving dynamics. By way of explanation, an axle 107a of a roller 107 is shown, which forms a tangent at a center line 103a, which connects the center points of the rollers 107 to one another.

An alternative embodiment of a rear rolling device 207 is shown in FIG. 10. In this case, barrel-shaped rollers 207 are arranged on the carrier element 108. This enables substantially less wear. In the two above-mentioned embodiment variants, roller bearings 109 are arranged in the rollers 107 or 207, respectively. The axles 207a are also tangents on the center line 203a here and enclose an angle 217, which is approximately 12°.

A plane 110, which is formed by the axles of the rollers 107 of the rear rolling device 103, is shown in FIG. 11 and FIG. 12. In FIG. 11, this plane is perpendicular to the deck 101. This enables pleasant riding dynamics, similarly to a wide rear tire. In FIG. 12, the plane is inclined to the rear. A feeling of sliding to the side can thus be generated. The carrier element 108 is preferably pivotably connected to the deck 101 to enable individual adaptation.

FIGS. 13 to 16 show the brake lever in detail. The brake lever has an actuating surface 112 and a friction block 113, wherein the friction block 113 has at least one curved friction surface 114 adapted to the shape of the carrier element 108. A force distributed uniformly onto all rollers is thus transmitted upon actuation of the brake via the actuating surface 112. The braking action is thus constant, independently of the roller presently touching the ground.

1. A kick scooter comprising:
a deck,
a handlebar arranged at an angle relative to the deck, and
a front rolling device, and
a rear rolling device including
a plurality of rollers arranged along a curved carrier element, and
axles for each of the plurality of rollers, each of the axles essentially form a tangent on a center line of the carrier element.

2. The kick scooter according to claim 1, characterized in that the plurality of rollers of the rear rolling device are arranged essentially adjacent to one another.

3. The kick scooter according to claim 1, wherein the axles are located in a plane, and wherein one axle has an angle in relation to an adjacent axle which is between 3° and 20°.

4. The kick scooter according to claim 3, characterized in that the plane has an angle in relation to a perpendicular on the deck which is less than 30°.

5. The kick scooter according to claim 3, characterized in that the carrier element is a circular arc.

6. The kick scooter according to claim 1, characterized in that the plurality of rollers of the rear rolling device are arranged offset relative to a longitudinal axis of the kick scooter.

7. The kick scooter according to claim 1, characterized in that the carrier element is configured and arranged to pivot around a transverse axis of the kick scooter.

8. The kick scooter according to claim 1, wherein the front rolling device is a single steerable wheel and the wheel is arranged on the handlebar.

9. The kick scooter according to claim 1, characterized in that the rear rolling device includes three to eleven rollers.

10. The kick scooter according to claim 1, further including a friction block and a brake lever arranged in a region of the rear rolling device on which the friction block is arranged, and which has a parallel shape to the carrier element, the friction block configured and arranged to act on the plurality of roller simultaneously and essentially uniformly.

11. The kick scooter according to claim 1, characterized in that the handlebar is configured and arranged to collapse toward the deck.

12. The kick scooter according to claim 1, characterized in that the plurality of rollers are mounted to the axles via roller bearings.

13. The kick scooter of claim 1, wherein the front rolling device is a single steerable wheel.

14. The kick scooter of claim 3, wherein the angle between the one axle and the adjacent axle is between 8° and 15°.

15. The kick scooter of claim 4, wherein the plane is selectable by a user.

16. The kick scooter of claim 1, wherein the plurality of rollers includes five to nine rollers.

17. The kick scooter of claim 1, wherein the plurality of rollers includes seven rollers.
